(19) United States
(12) Patent Application Publication
(10) Pub. No.: US 2017/0311325 A1
(43) Pub. Date: Oct. 26, 2017

(54) STATION (STA), ACCESS POINT (AP) AND METHOD FOR MULTI-BAND CHANNEL BONDING

(71) Applicants: Laurent Cariou, Portland, OR (US); Robert J. Stacey, Portland, OR (US)

(72) Inventors: Laurent Cariou, Portland, OR (US); Robert J. Stacey, Portland, OR (US)

(21) Appl. No.: 15/381,413

(22) Filed: Dec. 16, 2016

Related U.S. Application Data
(60) Provisional application No. 62/326,307, filed on Apr. 22, 2016.

(51) Int. Cl. H04W 72/04; H04B 7/0452; H04W 72/08; H04B 7/06; H04W 88/08; H04W 84/12

(52) U.S. Cl. CPC H04W 72/0453; H04W 72/085; H04B 7/0617; H04B 7/0452; H04W 84/12; H04W 88/08

(57) ABSTRACT

Embodiments of an access point (AP), station (STA) and method for channel sounding are generally described herein. The AP may contend for a transmission opportunity (TXOP) to obtain access to a bonded channel comprising a primary channel in a first frequency band and a secondary channel in a second frequency band. The AP may transmit a null data packet (NDP) announcement (NDPA) concurrently on the primary and secondary channels. The AP may transmit one or more NDPs concurrently on the primary and secondary channels, which may enable separate sounding measurements for the primary and secondary channels. The AP may decode one or more beamforming feedback (BF) frames that include the sounding measurements for the primary and secondary channels. The sounding measurements may be based on the training symbols of the NDPs.

### PRIORITY CLAIM

This application claims priority under 35 USC 119(e) to U.S. Provisional Patent Application Ser. No. 62/326,307, filed Apr. 22, 2016 [reference number P98427Z (9884.015PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi communications. Some embodiments relate to channel bonding, including channel bonding of multiple channels in different frequency bands.

### BACKGROUND

Wireless communications have been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates the operation of a method of communication in accordance with some embodiments;

FIG. 5 illustrates an example scenario of channel bonding in accordance with some embodiments;

FIG. 6 illustrates example physical layer convergence procedure protocol data units (PPDUs) in accordance with some embodiments;

FIG. 7 illustrates example operations in accordance with some embodiments;

FIG. 8 illustrates example frames that may be exchanged in accordance with some embodiments;

FIG. 9 illustrates the operation of another method of communication in accordance with some embodiments; and

FIG. 10 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

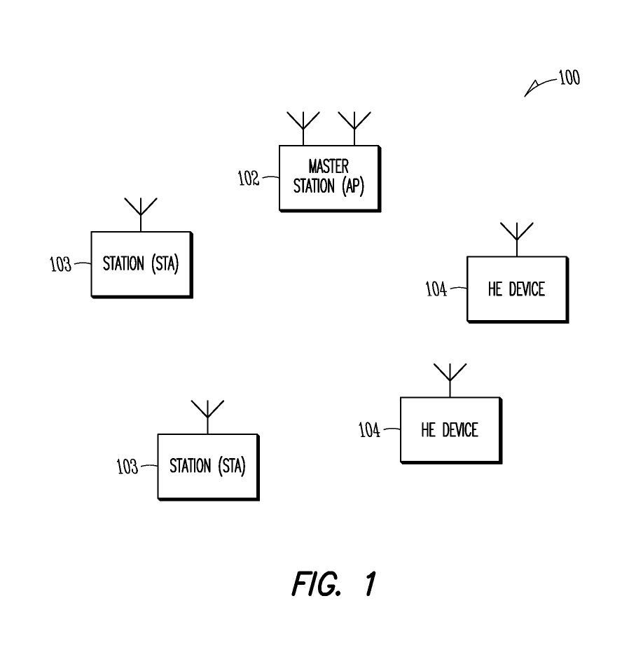

FIG. 1 illustrates a wireless network in accordance with some embodiments. In some embodiments, the network 100 may be a High Efficiency (HE) Wireless Local Area Network (WLAN) network. In some embodiments, the network 100 may be a WLAN or a Wi-Fi network. These embodiments are not limiting, however, as some embodiments of the network 100 may include a combination of such networks. That is, the network 100 may support HE devices in some cases, non HE devices in some cases, and a combination of HE devices and non HE devices in some cases. Accordingly, it is understood that although techniques described herein may refer to either a non HE device or to an HE device, such techniques may be applicable to both non HE devices and HE devices in some cases.

Referring to FIG. 1, the network 100 may include any or all of the components shown, and embodiments are not limited to the number of each component shown in FIG. 1. In some embodiments, the network 100 may include a master station (AP) 102 and may include any number (including zero) of stations (STAs) 103 and/or HE devices 104. In some embodiments, the AP 102 may transmit signals and/or frames to the STA 103 for sounding, and may transmit data packets to the STA 103. These embodiments will be described in more detail below.

The AP 102 may be arranged to communicate with one or more of the components shown in FIG. 1 in accordance with one or more IEEE 802.11 standards (including 802.11ax and/or others), other standards and/or other communication protocols. It should be noted that embodiments are not limited to usage of an AP 102. References herein to the AP 102 are not limiting and references herein to the master station 102 are also not limiting. In some embodiments, a STA 103, HE device 104 and/or other device may be configurable to operate as a master station. Accordingly, in such embodiments, operations that may be performed by the AP 102 as described herein may be performed by the STA 103, HE device 104 and/or other device that is configurable to operate as the master station.

In some embodiments, one or more of the STAs 103 may be legacy stations. These embodiments are not limiting, however, as the STAs 103 may be configured to operate as HE devices 104 or may support HE operation in some embodiments. The master station 102 may be arranged to communicate with the STAs 103 and/or the HE stations 104 in accordance with one or more of the IEEE 802.11 standards, including 802.11ax and/or others. In accordance with some HE embodiments, an access point (AP) may operate as the master station 102 and may be arranged to contend for a wireless medium (e.g., during a contention period) to receive exclusive control of the medium for an HE control period (i.e., a transmission opportunity (TXOP)). The master station 102 may, for example, transmit a master-sync or control transmission at the beginning of the HE control period to indicate, among other things, which HE stations 104 are scheduled for communication during the HE control period. During the HE control period, the scheduled HE stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HE control period, the master station 102 may communicate with HE stations 104 using one or more HE PPDUs. During the HE control period, STAs 103 not operating as HE devices may refrain from communicating in some cases. In some embodiments, the master-sync transmission may be referred to as a control and schedule transmission.

In some embodiments, the multiple-access technique used during the HE control period may be a scheduled orthogonal frequency-division multiple access (OFDMA) technique, although this is not a requirement. In some embodiments, the multiple access technique may be a time-division multiple access (TDMA) technique or a frequency-division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HE control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HE stations 104 outside the HE control period in accordance with legacy IEEE 802.11 communication techniques, although this is not a requirement.

In some embodiments, the HE communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In these embodiments, each channel or sub-channel of an HE communication may be configured for transmitting a number of spatial streams.

In some embodiments, high-efficiency (HE) wireless techniques may be used, although the scope of embodiments is not limited in this respect. As an example, techniques included in 802.11ax standards and/or other standards may be used. In accordance with some embodiments, a master station 102 and/or HE stations 104 may generate an HE packet in accordance with a short preamble format or a long preamble format. The HE packet may comprise a legacy signal field (L-SIG) followed by one or more HE signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

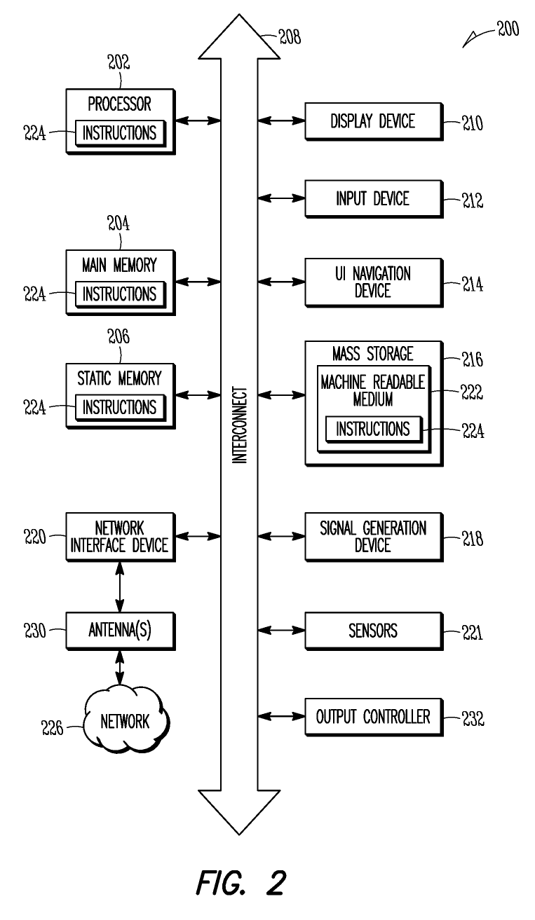

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HE device, HE AP, HE STA, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB)), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

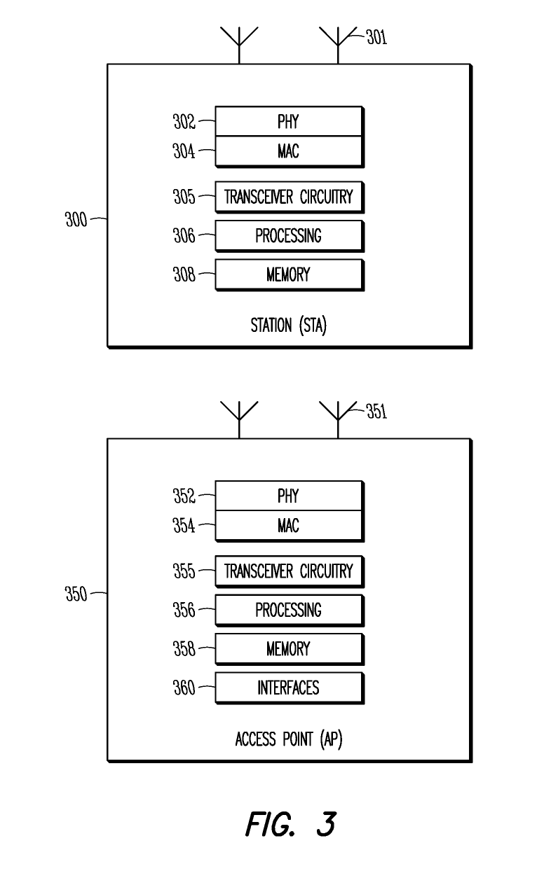

FIG. 3 illustrates a station (STA) in accordance with some embodiments and an access point (AP) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 350 may be suitable for use as an AP 102 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control (MAC) layer circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control (MAC) layer circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 may be configured as an HE device 104 (FIG. 1), and may communicate using OFDM and/or OFDMA communication signals over a multicarrier communication channel. In some embodiments, the AP 350 may be configured to communicate using OFDM and/or OFDMA communication signals over a multicarrier communication channel. In some embodiments, the HE device 104 may be configured to communicate using OFDM communication signals over a multicarrier communication channel. Accordingly, in some cases, the STA 300, AP 350 and/or HE device 104 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HE standards, although the scope of the embodiments is not limited in this respect as they may also be suitable to transmit and/or receive communications in accordance with other techniques and standards. In some other embodiments, the AP 350, HE device 104 and/or the STA 300 configured as an HE device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. Embodiments disclosed herein provide two preamble formats for High Efficiency (HE) Wireless LAN standards specification that is under development in the IEEE Task Group 11ax (TGax).

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA, in some embodiments. It should also be noted that in some embodiments, an apparatus used by the AP 350 may include various components of the AP 350 as shown in FIG. 3 and/or the example machine 200 as shown in FIG. 2. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In accordance with some embodiments, the AP 102 may contend for a transmission opportunity (TXOP) to obtain access to a bonded channel comprising a primary channel in a first frequency band and a secondary channel in a second frequency band. The AP 102 may transmit a null data packet (NDP) announcement (NDPA) concurrently on the primary and secondary channels. The AP 102 may transmit one or more NDPs concurrently on the primary and secondary channels, which may enable separate sounding measurements for the primary and secondary channels. The AP 102 may decode one or more beamforming feedback (BF) frames that include the sounding measurements for the primary and secondary channels. The sounding measurements may be based on the training symbols of the NDPs. These embodiments will be described in more detail below.

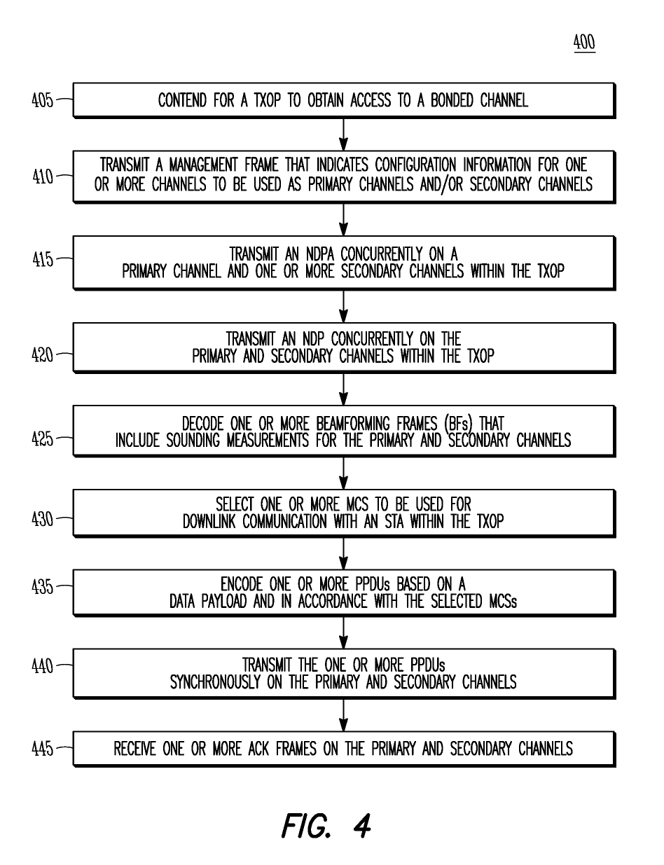

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-10, although it is understood that the method 400 may be practiced with any other suitable systems, interfaces and components.

In some embodiments, the AP 102 and/or STA 103 may be configurable to operate as an HE device 104. Although reference may be made to an AP 102 and/or STA 103 herein, including as part of the descriptions of the method 400 and/or other methods described herein, it is understood that an HE device 104, an AP 102 configurable to operate as an HE device 104 and/or STA 103 configurable to operate as an HE device 104 may be used in some embodiments. In addition, the method 400 and other methods described herein may be applicable to STAs 103, HE devices 104 and/or APs 102 operating in accordance with one or more standards and/or protocols, such as 802.11, Wi-Fi, wireless local area network (WLAN) and/or other, but embodiments of those methods are not limited to just those devices. In some embodiments, the method 400 and other methods described herein may be practiced by other mobile devices, such as an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103, HE device 104 and/or AP 102 or other device described above, in some embodiments.

It should also be noted that embodiments are not limited by references herein (such as in descriptions of the methods 400, 900, 1000 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 405 of the method 400, the AP 102 may contend for a transmission opportunity (TXOP) to obtain access to a bonded channel. In some embodiments, the AP 102 may contend for a transmission opportunity (TXOP) during which the AP 102 is to control access to a bonded channel that includes a primary channel in a first frequency band and a secondary channel in a second frequency band. In some embodiments, the AP 102 may contend for a wireless medium during a contention period to receive exclusive control of the medium during a period, including but not limited to a TXOP and/or HE control period. The AP 102 may transmit, receive and/or schedule one or more frames and/or signals during the period. The STA 103 may transmit and/or receive one or more frames and/or signals during the period. However, it should be noted that embodiments are not limited to scheduled transmission/reception or to transmission/reception in accordance with the exclusive control of the medium. Accordingly, an MPDU, PPDU, BA frame and/or other frame may be transmitted/received in contention-based scenarios and/or other scenarios, in some embodiments. Any suitable contention methods, operations and/or techniques may be used, which may or may not be part of a standard. In a non-limiting example, one or more contention methods, operations and/or techniques of an 802.11 standard/protocol and/or W-LAN standard/protocol may be used.

In some embodiments, the bonded channel may comprise a primary channel and one or more secondary channels. In a non-limiting example, the primary channel may be in a first frequency band and at least one secondary channel may be in a second frequency band. In such cases, it may be possible that the first frequency band includes the primary channel and one or more of the secondary channels. For instance, the bonded channel may be configurable to comprise the primary channel in a first frequency band, a secondary channel in a second frequency band, and one or more additional secondary channels. The additional secondary channels may be in either the first frequency band, second frequency band or both. In another non-limiting example, more than two frequency bands may be used. Accordingly, some or all of the operations, methods, techniques and/or concepts described herein may be extended to more than two frequency bands.

In some embodiments, the first frequency band may be a licensed frequency band and the second frequency band may be an unlicensed frequency band. In some embodiments, a combination of licensed and/or unlicensed frequency bands may be used. Any of the primary channel and/or secondary channels may be in licensed or unlicensed spectrum.

In some embodiments, one or more frequency ranges (such as cellular, microwave and/or other) may be used. For instance, the bonded channel may include a first channel in a first frequency band in a cellular range and a second channel in a second frequency band in a microwave range. This example is not limiting, however, as any suitable frequency band(s) may be used, including frequency band(s) that may or may not be in a same frequency range, frequency category or other.

In a non-limiting example, multiple protocols (physical layer or other) may be used for one or more different channels of the bonded channel. In another non-limiting example, a same protocol may be used on the channels of the bonded channel. Such protocols may include a wireless local area network (WLAN) protocol, 3GPP protocol and/or other suitable protocol. These examples are not limiting, however.

In some embodiments, bandwidths of the different channels (primary and secondary channels) may be of a same bandwidth. In some embodiments, one or more channels may be configurable for different bandwidths.

At operation 410, the AP 102 may transmit a frame that may indicate configuration information related to the bonded channel. For instance, the frame may indicate one or more channels which the AP 102 is configured to use as primary channels and/or one or more channels which the AP 102 is configured to use as secondary channels. Examples of such information may include, but are not limited to, whether a channel is configurable for usage as a primary channel and/or secondary channel, which channels may be used as a primary channels and/or secondary channel, which channels (such as a list) are to be used in the bonded channel, which channel is to be the primary channel of the bonded channel, which channel(s) are to be the secondary channel(s) of the bonded channel and/or other information.

In some embodiments, the frame may be a management frame, control frame, beacon frame and/or other frame. The frame may be included in a standard, such as 802.11, WLAN, 3GPP LTE and/or other, although embodiments are not limited to frames that are included in a standard. In a non-limiting example, such information may be included in a capabilities element (and/or other element) of the frame.

In some embodiments, the frame may be transmitted by the AP 102 as part of an establishment of an association between the AP 102 and one or more STAs 103 for communication on the bonded channel. In a non-limiting example, the establishment of the association may be restricted to the primary channel. For instance, messages for the establishment of the association may be exchanged between the AP 102 and the STA(s) 103 on the primary channel.

At operation 415, the AP 102 may transmit a null data packet (NDP) announcement (NDPA). In some embodiments, the NDP-A may be transmitted to indicate, to one or more STAs 103, that an NDP is to be transmitted by the AP 102. In addition, other information related to the NDP transmission may also be included, in some cases. In some embodiments, the NDP-A may be transmitted concurrently on the primary and secondary channel(s) of the bonded channel. In a non-limiting example, the NDPA may include NDP transmission information for the primary and secondary channel(s).

At operation 420, the AP 102 may transmit one or more NDPs within the TXOP. In some embodiments, an NDP may be transmitted concurrently on the primary and secondary channel(s) to enable separate sounding measurements for the primary and secondary channel(s). For instance, the STA 103 may perform separate sounding measurements on multiple channels based on the NDP received on each channel. In some embodiments, the NDP(s) may include training symbols, which may be used for the sounding measurements.

At operation 425, the AP 102 may receive one or more beamforming feedback (BF) frames that include the sounding measurements for the primary and secondary channel(s). In some embodiments, the BF frames may be received from the STA 103. In some embodiments, the BF frames may be received concurrently within the TXOP. In a non-limiting example, a BF frame may be received on the primary channel and a BF frame may be received on each of the secondary channel(s). In some cases, each BF frame may include sounding measurements of all the channels (primary channel and secondary channel(s)). For instance, a BF frame may be duplicated (and/or transmitted in a duplicate mode) on some or all of the channels. This example is not limiting, however. In another example, a BF frame on the primary channel may include a sounding measurement for the primary channel, and additional BF frames on the secondary channel(s) may include sounding measurements for those channels. In another example, any number of BF frames may be used and may include sounding measurement(s) for any number of channels.

In some embodiments, the sounding measurements may be based on the training symbols of the NDPs, although the scope of embodiments is not limited in this respect. The sounding measurements may be performed by the STA 103, although the scope of embodiments is not limited in this respect. Non-limiting examples of sounding measurements may include, but are not limited to, a signal quality measurement, a signal power measurement, a signal-to-noise ratio (SNR), received signal strength indicator (RSSI) and/or other. Such measurements may be performed per-channel (such as one measurement per channel), although the scope of embodiments is not limited in this respect. For instance, multiple channels may be used. In another non-limiting example, measurements per frequency band (such as on one or more channels of the bonded channel included in the band) may be performed.

In addition, embodiments are not limited to usage of BF frames, as other frames may be used to communicate the sounding measurements. It should be noted that BF frames and/or other frames may include other information in some cases. In addition, such frames may or may not be dedicated for communication of the sounding measurements. For instance, the frame (BF frame or other) may transport the sounding measurements in addition to other information, in some cases.

At operation 430, the AP 102 may select one or more modulation and coding schemes (MCSs) to be used for downlink communication with an STA 103 within the TXOP. In a non-limiting example, the downlink communication may include multi-user multiple-input multiple-output (MU-MIMO) communication, although the scope of embodiments is not limited in this respect. The MCS(s) may be selected based at least partly on the sounding measurements. In some embodiments, the MCS(s) may be selected from a candidate group of MCSs. For instance, a mapping between the MCSs of the candidate group and one or more thresholds may be used to select the MCS. In some cases, the mapping and/or threshold(s) may be predetermined, although the scope of embodiments is not limited in this respect. The MCSs of the candidate group may include different combinations of modulation type (and/or modulation constellation) and coding rate.

In some embodiments, the AP 102 may select one or more MCSs for one or more channels. In a non-limiting example, the AP 102 may select different MCSs for at least some of the channels. For instance, the AP 102 may select a first MCS for the primary channel and may select a second MCS for one of the secondary channels. In such cases, it may also be possible for the AP 102 to select a same MCS for two or more channels. In some embodiments, the AP 102 may perform a per-band selection of MCSs. For instance, an MCS may be selected for each band. In such cases, a first MCS for a first band may or may not be different from a second MCS for a second band.

The MCSs may be based on modulation types and forward error correction (FEC) coding rates. Example FEC coding rates may include, but are not limited to, 1/4, 1/3, 1/2, 2/3, 3/4 and/or other. Example modulation types may include, but are not limited to, binary phase shift keying (BPSK), quadrature phase shift keying (QPSK), and quadrature amplitude modulation (QAM) of different sizes. Example sizes of the QAM may include 16 level (16-QAM), 64 level (64-QAM) and/or other. In addition, the modulation type or the MCS may include or may be based on a mapping between bits and modulation symbols (such as constellation points). For instance, each modulation symbol of a 16-QAM constellation may be mapped to a block of 4 bits in accordance with a predetermined bit-to-symbol mapping. Encoding of data in accordance with the MCS may include coding (convolutional, block, turbo and/or other) in accordance with the coding rate of the MCS, and bit-to-symbol mapping in accordance with the modulation type. One or more other operations, such as interleaving, scrambling and/or other may also be used, in some embodiments.

At operation 435, the AP 102 may encode, based on one or more data payload, one or more physical layer convergence procedure protocol data units (PPDUs). In some embodiments, the PPDUs may be encoded for transmission to the STA 103, although the scope of embodiments is not limited in this respect. At operation 440, the AP 102 may transmit the one or more PPDUs on the primary channel and the secondary channel(s) of the bonded channel. In some embodiments, the PPDUs may be transmitted to the STA 103, although the scope of embodiments is not limited in this respect. In some embodiments, the PPDUs may be encoded for synchronized transmission on the bonded channel. In some embodiments, the PPDUs may be transmitted concurrently within the TXOP. In some embodiments, MU-MIMO techniques may be used for the transmission of the one or more PPDUs, although embodiments are not limited as such.

In a non-limiting example, a data payload may be encoded to generate modulated symbols, which may be included in multiple PPDUs. For instance, the modulated symbols may be distributed into multiple PPDUs for transmission on the multiple channels. In another non-limiting example, a data payload may be encoded to generate modulated symbols, which may be repeated and/or duplicated on one or more channels. In some embodiments, the PPDUs may be transmitted in accordance with downlink MU-MIMO communication, although the scope of embodiments is not limited in this respect.

In some embodiments, the PPDU(s) may be transmitted in one or more downlink signals. Any suitable format may be used for the downlink signal. As a non-limiting example, the downlink signal may be transmitted in channel resources that include multiple sub-carriers of a predetermined sub-carrier bandwidth. The downlink signal(s) may be an orthogonal frequency division multiplexing (OFDM) signal or an orthogonal frequency division multiple access (OFDMA) signal. Modulation symbols of the downlink signal(s) may be mapped to the sub-carriers for the OFDM signal or OFDMA signal. It should be noted that embodiments are not limited to OFDM signals or to OFDMA signals. As an example, single-carrier frequency division multiplexing (SC-FDM) signals may be used. As another example, modulation symbols of the downlink signal(s) may be multiplexed in time. The downlink signal(s) may be based on multiple modulation symbols, which may be encoded by one or more transmitter functions, including but not limited to FEC encoding, interleaving, scrambling and/or bit-to-symbol mapping.

In a non-limiting example, the AP 102 may encode, based on a data payload, first and second PPDUs for synchronized transmission on a bonded channel that includes a primary channel and a secondary channel. The first PPDU may be encoded based on a first MCS (selected for the primary channel) for transmission on the primary channel. The second PPDU may be encoded based on a second MCS (selected for the secondary channel) for transmission on the secondary channel. In some embodiments, the first and second PPDUs may include physical layer (PHY) headers that indicate that the primary and secondary channels are used for the transmissions of the first and second PPDUs. Embodiments are not limited to the usage of PHY headers, however, as other headers, messages, frames and/or other elements may be used in some cases.

In some embodiments, PPDUs encoded for transmission on the channels of the bonded channel may include physical layer (PHY) headers that include control information related to the frequency bands of the primary channel and the secondary channel(s). In a non-limiting example, the control information may be repeated in the PHY headers of the PPDUs of the primary and secondary channels, in some cases. In another non-limiting example, the control information in the PHY header of the PPDU of a particular channel may be dependent on the frequency band of the particular channel. For instance, the PHY header of a PPDU of a particular channel in a particular frequency band may include control information for other channels of the frequency band and may exclude control information for other channels of other frequency band(s).

At operation 445, the AP 102 may receive one or more ACK frames. In some embodiments, the ACK frames may be received from the STA 103, although the scope of embodiments is not limited in this respect. The ACK frame(s) may include information (such as ACK bits and/or indicators of whether reception of PPDU(s) is successful) related to the PPDUs transmitted at operation 440. The ACK frame(s) may include information related to other PPDUs, in some cases. Additional information may also be included in the ACK frames, in some cases.

In some embodiments, the AP 102 may transmit a trigger frame (TF). In a non-limiting example, the TF may indicate information to be used by the STA 103 to exchange one or more frames and/or signals (such as the PPDUs of operation 440) with the AP 102 during a transmission opportunity (TXOP). Example frames may include, but are not limited to, MPDUs, PPDUs and/or BA frames. Example information of the TF may include, but is not limited to, time resources to be used for transmission/reception, channel resources to be used for transmission/reception, identifiers of STAs 103 that are to transmit, identifiers of STAs 103 that are to receive and/or other information. It should be noted, however, that embodiments are not limited to usage of the TF, and some embodiments may not necessarily include the usage of the TF.

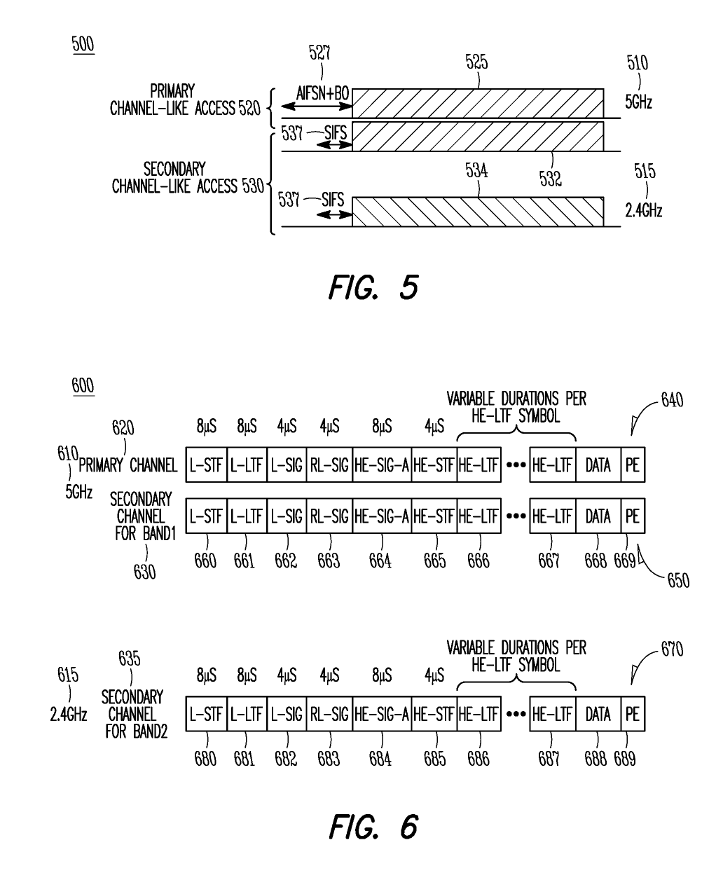

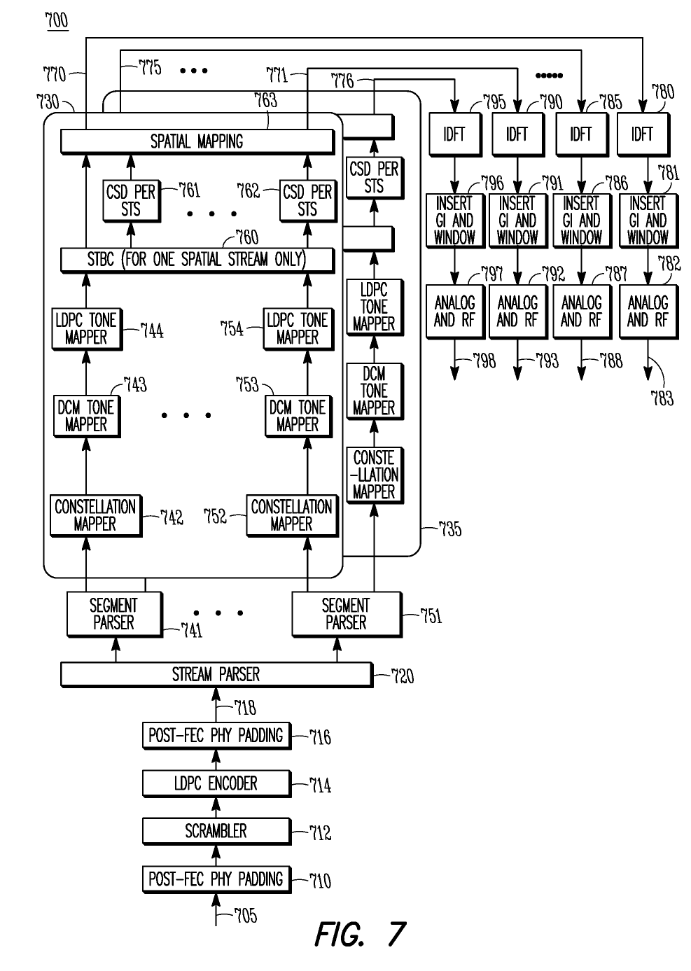

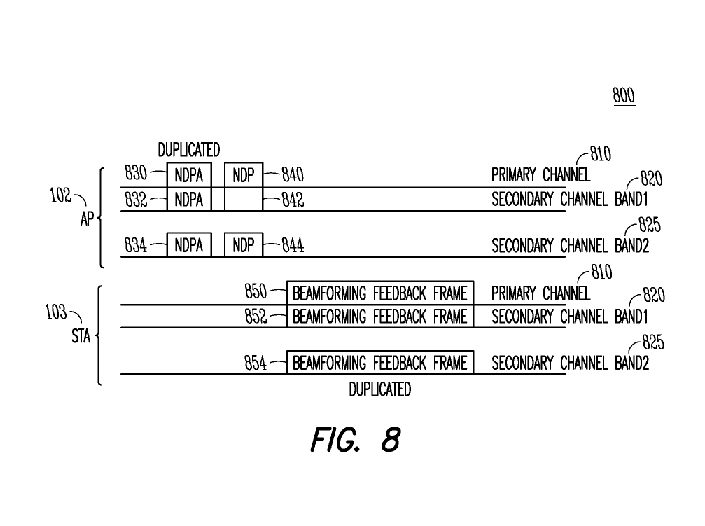

FIG. 5 illustrates an example scenario of channel bonding in accordance with some embodiments. FIG. 6 illustrates example physical layer convergence procedure protocol data units (PPDUs) in accordance with some embodiment. FIG. 7 illustrates example operations in accordance with some embodiments. FIG. 8 illustrates example frames that may be exchanged in accordance with some embodiments. It should be noted that the examples shown in FIGS. 5-8 may illustrate some or all of the concepts and techniques described herein in some cases, but embodiments are not limited by the examples of FIGS. 5-8. For instance, embodiments are not limited by the name, number, type, size, ordering, arrangement and/or other aspects of the frames, signals, fields, data blocks, operations, time resources, channels, frequency bands, and other elements as shown in FIGS. 5-8. Although some of the elements shown in the examples of FIGS. 5-8 may be included in an 802.11 standard and/or other standard, embodiments are not limited to usage of such elements that are included in standards.

In some embodiments, channel bonding of multiple channels may be used. In some cases, the channels may be non-contiguous and on different frequency bands. In a non-limiting example, the bonded channel may comprise a primary channel, and one or more secondary channels. Various configurations are possible, including but not limited to: the secondary channels may be adjacent to the primary channel; the secondary channels may be non-adjacent to the primary channel and in the same frequency band as the primary channel; the secondary channels may be non-adjacent to the primary channel and in a different frequency band as the primary channel.

In some embodiments, time synchronization between the transmissions on each channel/band may be used. For instance, time alignment of OFDM symbols may be used. In a non-limiting example, a same OFDM modulation with at least some of the same OFDM parameters (symbol duration, guard interval duration and/or other) may be used on the different channels and/or frequency bands. In some embodiments, an aggregation of channels of a same bandwidth may be performed. In some embodiments, the aggregation may be configurable for different bandwidth sizes on at least some of the channels.

Referring to FIG. 5, in the example scenario 500, the AP 102 may obtain access to a bonded channel that comprises a primary channel (indicated by 520) and one or more secondary channels (as indicated by 530). In this example, the primary channel and one of the secondary channels are at a first frequency band, which may be near to, centered at, or may include 5 GHz (as indicated by 510). The other secondary channel may be at a second frequency band, which may be near to, centered at, or may include 2.4 GHz (as indicated by 515). In the example scenario 500, a first PPDU 525 and a second PPDU 532 may be transmitted in the first frequency band at 5 GHz. A third PPDU 534 may be transmitted in the second frequency band at 2.4 GHz. Various contention delays, back-offs, inter-frame spaces (IFS) and/or other periods may be used, which may or may not be part of a standard. For instance, an arbitrary inter-frame space (AIFS), short inter-frame space (SIFS), a back-off (BO) and/or other may be used, although embodiments are not limited to these examples.

Referring to FIG. 6, in the example scenario 600, the PPDU 640 may be transmitted on the primary channel 620, the PPDU 650 may be transmitted on the secondary channel 630, and the PPDU 670 may be transmitted on the secondary channel 635. The primary channel 620 and the secondary channel 630 may be in a first frequency band (such as one that is at or near to 5 GHz and/or one that includes 5 GHz). The secondary channel 635 may be in a second frequency band (such as one that is at or near to 5 GHz and/or one that includes 2.4 GHz). The PPDUs 640, 650, 670 may include one or more of the fields shown in FIG. 6, and may include additional, similar and/or alternate fields in some embodiments. As shown for PPDU 650, example fields may include, but are not limited to, a legacy short training field (L-STF) 660, legacy long training field (L-LTF) 661, legacy signal field (L-SIG) 662, repeated L-SIG 663, HE-SIG-A, HE-STF 666, HE-LTF 667, data 668 and/or packet extension (PE) 669. Similar fields and/or same fields may be included in PPDUs 640, 670. In some cases, one or more of the fields may be repeated on multiple PPDUs. In some cases, one or more of the fields may be different (such as the data fields, which may be different in different PPDUs, in some cases).

In a non-limiting example scenario, a bonded channel may include two channels (including a primary channel and a secondary channel) in a first frequency band. The bonded channel may also include another secondary channel in a second frequency band. A channel coding operation may be spread on all the channels of the bonded channel. After channel encoding, a stream parser may de-multiplex the flow into two segments, one per band. Each segment may then apply the remaining PHY processing up to the iFFT (OFDM transmission) which may be applied per band. In some cases, some or all of the PHY processing may be shared between the different bands. The digital to analog conversion and RF processing may be separated between the different bands, in some cases

Referring to FIG. 7, example transmit/encoder functions are illustrated. A data payload, data packet and/or group of bits (such as 705 in FIG. 7) may be encoded using one or more of these functions and/or other functions to generate one or more PPDUs. The example 700 shows an organization into multiple chains, some of which are per-channel (such as 742-744 as a first chain and 752-754 as a second chain) and some of which are per-band (730 and 735). It should be noted that embodiments are not limited to the organization shown. Some or all operations shown (and in some cases, additional operations) may be implemented in any suitable manner that may or may not be organized per-channel and/or per-band.

In the example 700, the operations 710-716 (which may be part of a single chain, in some cases) may be applied and the output 718 may be input to the stream parser 720. Multiple outputs of the stream parser 720 may be input to one or more parsers (such as segment parsers 741 and 751) for input to blocks 730 and 735. In a non-limiting example, the PPDUs may be output from block 720. In another non-limiting example, the PPDUs may be output from blocks such as 741 and 751. The scope of embodiments is not limited by these examples, however, as the PPDUs may be output from any suitable function, including but not limited to those shown in FIG. 7.

The block 730 may include various functions related to a first frequency band and the block 735 may include various functions related to a second frequency band. The first chain 742-744 (which includes a constellation mapper 742, DCM tone mapper 743, and an LDPC tone mapper 744) and the second chain 752-754 (which includes similar blocks 752-754) may be applied to generate outputs 770 and 771. The block 735 may generate similar outputs 775 and 776. The output 770 may be input to the chain 780-782 to generate output 783. The output 771 may be input to the chain 790-792 to generate output 793. The output 775 may be input to the chain 785-787 to generate output 788. The output 776 may be input to the chain 795-797 to generate output 798.

Referring to the example operations shown in FIG. 7, one or more transmit/encode operations may be performed. In some embodiments, the AP 102 may perform one or more of the transmit/encode operations to generate one or more PPDUs for downlink transmission. Embodiments are not limited to performance of the one or more transmit/encode operations by the AP 102, however. The STA 103 may use one of more of the transmit/encode operations to generate PPDUs for uplink transmission.

Referring to FIG. 8, the scenario 800 illustrates example frames that may be exchanged between the AP 102 and the STA 103. In this example scenario 800, the primary channel 810 and two secondary channels 820, 825 may be used, although embodiments are not limited to this arrangement, to the number of channels shown or to the number of frequency bands shown. The primary channel 810 and the secondary channel 820 may be in a first frequency band. The secondary channel 825 may be in a second frequency band. This example may be extended to additional frequency bands and/or additional channels.

The AP 102 may transmit an N-DPA 830, 832, 834 concurrently on the channels 810, 820, 825. The N-DPA 830, 832, 834 may be duplicated on the channels 810, 820, 825 (which may be in a duplicate mode, in some cases). The AP 102 may transmit an NDP 840, 842, 844 concurrently on the channels 810, 820, 825. The NDP 840, 842, 844 may be duplicated on the channels 810, 820, 825 (which may be in a duplicate mode, in some cases). The scope of embodiments is not limited to duplication of the N-DPA and/or NDP, as different N-DPAs and/or different NDPs on at least some of the channels may be used, in some embodiments.

The STA 103 may transmit a beamforming feedback frame 850, 852, 854 concurrently on the channels 810, 820, 825. The beamforming feedback frame 850, 852, 854 may be duplicated on the channels 810, 820, 825 (which may be in a duplicate mode, in some cases). The scope of embodiments is not limited to duplication of the beamforming feedback frame, as different beamforming feedback frames on at least some of the channels may be used, in some embodiments.

In some embodiments, the AP 102 and/or STAs 103 may advertise their capabilities. In a non-limiting example, such capabilities in a capabilities element and/or other element/frame. For instance, an STA and AP capabilities element (such as an element that advertises STA capabilities and/or AP capabilities) may be used. In some embodiments, the STAs 103 may be associated in the primary channel. For instance, association messages may be restricted to the primary channel, in which case they may not be transmitted in the secondary channel(s). In some cases, similarly to secondary channel usage in the same band, further control or management signaling (association exchanges, beacons and/or other) may not necessarily be sent on secondary channels of the other band. This can however be possible using duplicate mode an all secondary channels, in some cases. In some embodiments, the AP 102 may advertise the channels on which it operates (and/or may operate) as a primary channel or as a secondary channel, and in the different bands. In some embodiments, the STA 103 that is multi-band channel bonding capable may advertise that it can receive or transmit data on some or all of the channels on which the AP 102 operates. This can be done with management frame exchanges in the primary channel, or through regular pre-association frame exchanges.

In some embodiments, at the beginning of a PPDU transmission, the PHY headers may include the information about the channels on which the PPDU is transmitted. Various arrangements are possible, including but not limited to the following. In a non-limiting example, the PHY headers may be duplicated in all channels in all bands and the PHY headers may include an indication of the channels that are used for the PPDU transmission (such as a list of channels in different bands, total bandwidth per band, a bitmap of the channels that are known as being the operating channels from the AP 102 and/or other). In another non-limiting example, the PHY headers may be different in different bands, and may include per-band specific information. For instance, per-band channel allocation information may be included. In another non-limiting example, the PHY headers may be duplicated in all channels and may not necessarily include any bandwidth/channel information about the other bands. The receiver, by detecting the preambles on the channels in other bands, and by checking the time alignment of the signals may then implicitly know that the secondary channels in such bands are active and used for the PPDU transmission.

In some cases, the channels of the bonded channel may have a same or similar range. Accordingly, in such cases, if the STA 103 can connect to the AP 102 on the primary channel, it may also connect with a similar SNR on the other channel(s). In other cases, however, different channels of the bonded channel may have different ranges. For instance, channels of different frequency bands may have different ranges. With channels belonging to different frequency bands, the propagation can be very different, as well as PHY parameters like transmit power and/or others. It may be possible, in some cases, that a link can be established on one band but not on another one.

In some embodiments, after establishing the link on the primary channel, the links on other channels may be checked. For instance, links on channels in different bands than the band of the primary channel may be checked. The links on channels in the same band as the primary channel may also be checked. In some embodiments, a channel sounding procedure may be used to enable sounding on different bands. Channel sounding feedback may be included in the existing frames.

In some embodiments, the NDPA frame may include information of all the channels from the different bands on which channel sounding will be performed. This NDPA may be sent on all channels/bands using duplicate mode. The NDP may be sent also on all channels in all bands. In a non-limiting example, in a first frequency band, two channels may be bonded. In this case, the NDP may be a channel bonded NDP of 2 adjacent channels (although non-adjacent channels in the same band are also possible, in some cases). In a second frequency band, one channel (a secondary channel) may be included in the bonded channel, so the NDP may be transmitted in the secondary channel in the second band. Accordingly, the STA 103 may estimate the channel and may provide feedback to the AP 102 by including all feedback information in a beamforming feedback frame. This beamforming frame may be duplicated on all channels in all bands. In a non-limiting example, the feedback may include an SNR per band. Additional feedback and/or alternate feedback may also be included, in some cases.

In some embodiments, link aggregation may be transparent to the upper layers. In some cases, the PPDU may be either spread over all (or at least some) of the channels to increase reliability. In some cases, the PPDU may be transmitted per channel or per band. In some embodiments, in order to improve link adaptation, MCS (and possibly other PHY related parameters) selection per band (or even per channel) may be performed. In such cases, the MCS and other PHY related parameters of a specific band/channel are defined in the PHY preamble of the band/channel and the content of PHY preamble from different bonded channels/band can be different. Similarly, the link adaptation feedbacks can be defined per band/channel. Alternatively, link adaptation (including MCS selection and/or other operations) can be done on the whole bonded channel, with common parameters across all bands/channels, in some embodiments.

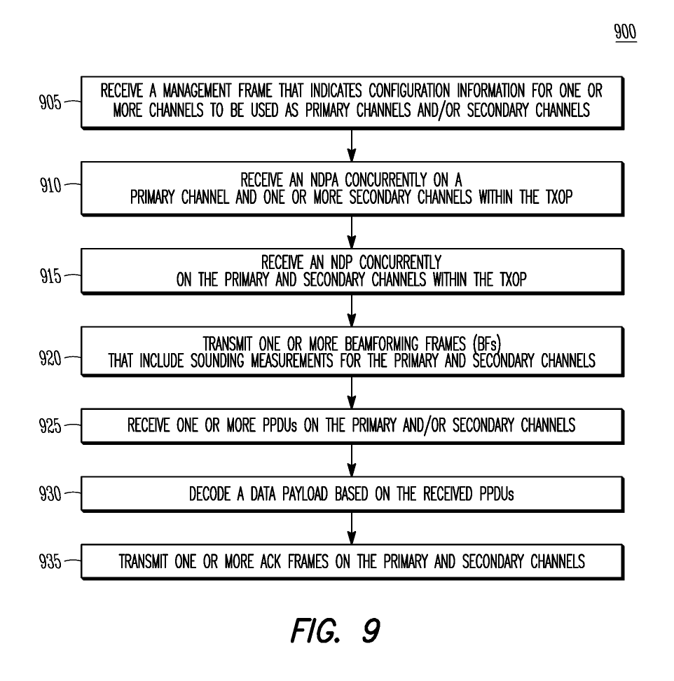

FIG. 9 illustrates the operation of another method of communication in accordance with some embodiments. As mentioned previously regarding the method 400, embodiments of the method 900 may include additional or even fewer operations or processes in comparison to what is illustrated in FIG. 9 and embodiments of the method 900 are not necessarily limited to the chronological order that is shown in FIG. 9. In describing the method 900, reference may be made to FIGS. 1-8 and 10, although it is understood that the method 900 may be practiced with any other suitable systems, interfaces and components.

In some embodiments, the STA 103 may be configurable to operate as an HE device 104. Although reference may be made to an STA 103 herein, including as part of the descriptions of the method 900 and/or other methods described herein, it is understood that an HE device 104 and/or STA 103 configurable to operate as an HE device 104 may be used in some embodiments. In addition, embodiments of the method 900 may be applicable to APs 102, STAs 103, UEs, eNBs or other wireless or mobile devices. The method 900 may also be applicable to an apparatus for an AP 102, STA 103 and/or other device described above.

It should be noted that the method 400 may be practiced by an AP 102 and may include exchanging of elements, such as frames, signals, messages, fields and/or other elements, with an STA 103. Similarly, the method 900 may be practiced at an STA 103 and may include exchanging of such elements with an AP 102. In some cases, operations and techniques described as part of the method 400 may be relevant to the method 900. In addition, embodiments of the method 900 may include operations performed at the STA 103 that are reciprocal to or similar to other operations described herein performed at the AP 102 as part of the method 400. For instance, an operation of the method 900 may include reception of a frame from the AP 102 by the STA 103 while an operation of the method 400 may include transmission of the same frame or similar frame by the AP 102.

In addition, previous discussion of various techniques and concepts may be applicable to the method 900 in some cases, including channel bonding, primary channel, secondary channel, NDP-A, NDP, sounding measurements, BF frames, PPDUs, transmission of PPDUs in accordance with channel bonding, trigger frames (TFs), MCSs, rate adaptation, candidate group of MCSs, BA frames, transmit/encoder operations, receive/decoder operations and/or others. In addition, one or more of the examples shown in FIGS. 5-8 may also be applicable, in some cases, although the scope of embodiments is not limited in this respect.

At operation 905 of the method 900, the STA 103 may receive a management frame that indicates configuration information for one or more channels to be used as primary channels and/or secondary channels. In some embodiments, the management frame may be received from the AP 102, although the scope of embodiments is not limited in this respect.

At operation 910, the STA 103 may receive an NDPA concurrently on a primary channel and one or more secondary channels within the TXOP. In some embodiments, the NDPA may be received from the AP 102, although the scope of embodiments is not limited in this respect. At operation 915, the STA 103 may receive an NDP concurrently on the primary and secondary channels within the TXOP. In some embodiments, the NDP may be received from the AP 102, although the scope of embodiments is not limited in this respect.

At operation 920, the STA 103 may transmit one or more beamforming frames (BFs) that include sounding measurements for the primary and secondary channels. In some embodiments, the beamforming frame(s) may be transmitted to the AP 102, although the scope of embodiments is not limited in this respect. At operation 925, the STA 103 may receive one or more PPDUs on the primary and/or secondary channels. In some embodiments, the PPDU(s) may be received from the AP 102, although the scope of embodiments is not limited in this respect. At operation 930, the STA 103 may decode one or more data payloads based on the received PPDU(s). At operation 935, the STA 103 may transmit one or more ACK frames on the primary and secondary channels. In some embodiments, the ACK frame(s) may be transmitted to the AP 102, although the scope of embodiments is not limited in this respect. It should be noted that one or more of operation 905-935 may be performed within a TXOP obtained by the AP 102, although the scope of embodiments is not limited in this respect.

It should be noted that some operations are described herein as part of downlink transmission of data. That is, the AP 102 may generate PPDU(s) for downlink transmission, may receive feedback from the STA 103, and may perform one or more operations (such as selection of an MCS to be used for the downlink transmission of subsequent PPDU(s) and/or other operations). Embodiments are not limited to downlink transmission of data, however. In some embodiments, one or more operations and/or techniques described herein may be performed as part of uplink transmission of data.

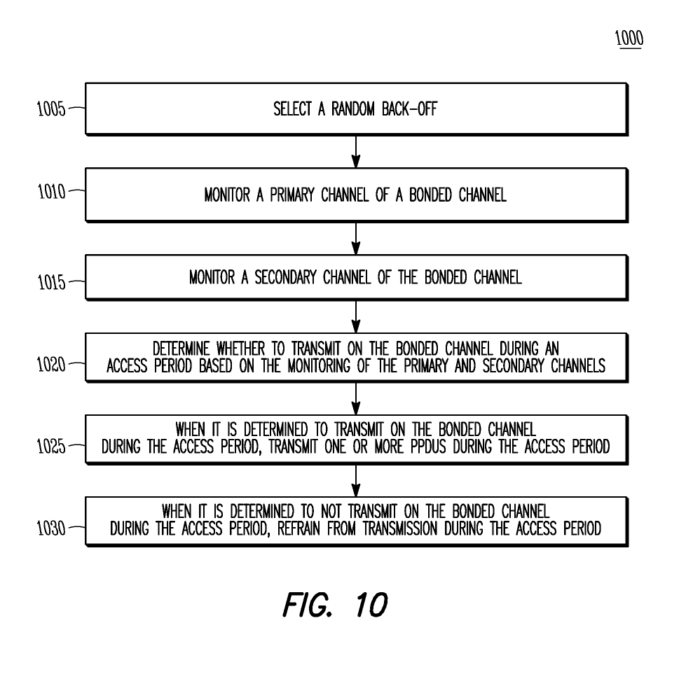

FIG. 10 illustrates the operation of another method of communication in accordance with some embodiments. As mentioned previously regarding the method 400, embodiments of the method 1000 may include additional or even fewer operations or processes in comparison to what is illustrated in FIG. 10 and embodiments of the method 1000 are not necessarily limited to the chronological order that is shown in FIG. 10. In describing the method 1000, reference may be made to FIGS. 1-9, although it is understood that the method 1000 may be practiced with any other suitable systems, interfaces and components.

Although the method 1000 may be described in terms of operations performed by an STA 103, such descriptions are not limiting. The method 1000 and/or operations of the method 1000 may be practiced by an STA 103, AP 102 and/or other device. It should be noted that some embodiments may include one or more operations from any of the methods 400, 900, 1000 and/or others. In some embodiments, a method may include one or more operations of the method 1000 and may further include one or more operations of the method 400. In some embodiments, a method may include one or more operations of the method 1000 and may further include one or more operations of the method 900. The method 1000 and/or other methods may also be applicable to an apparatus for an AP 102, STA 103 and/or other device described above.

In addition, previous discussion of various techniques and concepts may be applicable to the method 1000 in some cases, including channel bonding, primary channel, secondary channel, NDP-A, NDP, sounding measurements, BF frames, PPDUs, transmission of PPDUs in accordance with channel bonding, trigger frames (TFs), MCSs, rate adaptation, candidate group of MCSs, BA frames, transmit/encoder operations, receive/decoder operations and/or others. In addition, one or more of the examples shown in FIGS. 5-8 may also be applicable, in some cases, although the scope of embodiments is not limited in this respect.

At operation 1005, the STA 103 may select a random back-off count. Any suitable technique(s) may be used. For instance, an enhanced distributed coordination access (EDCA) technique and/or parameter may be used as part of any of the operations of the method 1000.

In some embodiments, a bonded channel may include a primary channel and a secondary channel. In an example, the primary channel may be in a first frequency band and the secondary channel may be in a second frequency band. Accordingly, the bonded channel may be a multi-band channel, in some cases. In addition, embodiments are not limited to two channels or to two frequency bands. The bonded channel may include multiple secondary channels, in some embodiments. More than two frequency bands may be used, in some embodiments.

At operation 1010, the STA 103 may monitor the primary channel during a first time period to determine whether the primary channel is idle. At operation 1015, the STA 103 may monitor the secondary channel during a second time period to determine whether the secondary channel is idle. For instance, the STA 103 may monitor for transmission activity from other devices, signals from other devices, interference caused by other devices and/or other. In some embodiments, a starting time of the second time period may be later than a starting time of the first time period. Accordingly, the second time period may be shorter than the first time period, in some cases.

At operation 1020, the STA 103 may determine whether to transmit on the bonded channel during an access period subsequent to the first and second time periods based on the monitoring of the primary and secondary channels. In some embodiments, the STA 103 may determine whether access to the bonded channel has been obtained based on the monitoring of the primary and secondary channels. The STA 103 may determine to transmit on the bonded channel (and/or that access has been obtained) during the access period when the primary channel is determined as idle for a duration of at least the back-off count plus an arbitrary inter-frame space number (AIFSN) and when the secondary channel is determined as idle for a duration of at least a short inter-frame space (SIFS). The STA 103 may otherwise determine to refrain from transmission (and/or that access has been obtained) on the bonded channel during the access period. Accordingly, when the primary channel or secondary channel is determined as not idle during such time periods, the STA 103 may determine to refrain from transmission on the bonded channel during the access period.

At operation 1025, when it is determined to transmit on the bonded channel during the access period, the STA 103 may transmit first and second physical layer convergence procedure protocol data units (PPDUs) on the bonded channel during the access period. Such transmission may be synchronized, simultaneous, concurrent and/or overlapping, in some cases. The PPDUs may be based on a data payload, in some cases. At operation 1030, when it is determined to not transmit on the bonded channel during the access period, the STA 103 may refrain from transmission on the bonded channel during the access period.

Referring to FIG. 5, a non-limiting example scenario 500 is shown. The transmission 525 on the primary channel may be performed after a period 527 that is a summation of the AIFSN and the back-off. The transmissions 532 and 534 on the secondary channels may be performed after a period 537 that is equal to the SIFS. It should be noted that in this example, the period 537 is shorter than the period 527 and begins after the beginning of the period 527.

In Example 1, an apparatus of an access point (AP) may comprise memory. The apparatus may further comprise processing circuitry. The processing circuitry may be configured to contend for a transmission opportunity (TXOP) to obtain access to a bonded channel comprising a primary channel in a first frequency band and a secondary channel in a second frequency band. The processing circuitry may be further configured to encode a null data packet (NDP) announcement (NDPA) for concurrent transmission on the primary and secondary channels, wherein the NDPA includes NDP transmission information for the primary and secondary channels. The processing circuitry may be further configured to encode one or more NDPs that include training symbols, the NDPs for concurrent transmission on the primary and secondary channels to enable separate sounding measurements for the primary and secondary channels. The processing circuitry may be further configured to decode one or more beamforming feedback (BF) frames that include the sounding measurements for the primary and secondary channels, the sounding measurements based on the training symbols of the NDPs.

In Example 2, the subject matter of Example 1, wherein the processing circuitry may be further configured to encode, for transmission, a frame that includes a capabilities element that indicates: one or more channels which the AP is configured to use as primary channels, or one or more channels which the AP is configured to use as secondary channels.

In Example 3, the subject matter of one or any combination of Examples 1-2, wherein the processing circuitry may be further configured to select, based at least partly on the sounding measurements, a first modulation and coding scheme (MCS) for the primary channel and a second MCS for the secondary channel. The first and second MCSs may be used for transmission of downlink multi-user multiple-input multiple-output (MU-MIMO) communications to a station (STA) within the TXOP.

In Example 4, the subject matter of one or any combination of Examples 1-3, wherein the processing circuitry may be further configured to encode, based on a data payload, first and second physical layer convergence procedure protocol data units (PPDUs) for synchronized transmission on the bonded channel as part of the downlink MU-MIMO communications. The first PPDU may be encoded based on the first MCS for transmission on the primary channel. The second PPDU may be encoded based on the second MCS for transmission on the secondary channel.

In Example 5, the subject matter of one or any combination of Examples 1-4, wherein the first and second PPDUs may include physical layer (PHY) headers that indicate that the primary and secondary channels are used for the transmissions of the first and second PPDUs.

In Example 6, the subject matter of one or any combination of Examples 1-5, wherein the bonded channel may be configurable to comprise one or more additional secondary channels in the first frequency band or second frequency band. The processing circuitry may be further configured to encode, based on the data payload, additional PPDUs for transmission in the additional secondary channels as part of the synchronized transmission on the bonded channel.

In Example 7, the subject matter of one or any combination of Examples 1-6, wherein the PPDUs may include physical layer (PHY) headers that include control information related to the frequency bands of the primary channel and the secondary channels. The control information may be repeated in the PHY headers of the PPDUs of the primary and secondary channels.

In Example 8, the subject matter of one or any combination of Examples 1-7, wherein the PPDUs may include physical layer (PHY) headers that include control information related to the frequency bands of the primary channel and the secondary channels. The control information in the PHY header of the PPDU of a particular channel may be dependent on the frequency band of the particular channel.

In Example 9, the subject matter of one or any combination of Examples 1-8, wherein the processing circuitry may be further configured to select the first and second MCSs as a same MCS or as two different MCSs.

In Example 10, the subject matter of one or any combination of Examples 1-9, wherein the sounding measurements may include a first signal quality measurement for the primary channel and a second signal quality measurement for the secondary channel. The processing circuitry may be further configured to select the first and second MCSs from a candidate group of MCSs based at least partly on one or more predetermined thresholds.

In Example 11, the subject matter of one or any combination of Examples 1-10, wherein the AP may be arranged to operate in accordance with a wireless local area network (WLAN) protocol.

In Example 12, the subject matter of one or any combination of Examples 1-11, wherein the processing circuitry may be further configured to encode, for transmission, a control frame or a management frame to establish an association between the AP and a station (STA) for communication on the bonded channel. The establishment of the association may be restricted to the primary channel.

In Example 13, the subject matter of one or any combination of Examples 1-12, wherein the first frequency band may be a licensed frequency band and the second frequency band may be an unlicensed frequency band.

In Example 14, the subject matter of one or any combination of Examples 1-13, wherein the processing circuitry may include a baseband processor to encode the NDPA, encode the NDP, and decode the one or more BF frames.

In Example 15, the subject matter of one or any combination of Examples 1-14, wherein the apparatus may further include a transceiver to transmit the NDPA, transmit the NDP and receive the one or more BF frames.

In Example 16, a non-transitory computer-readable storage medium may store instructions for execution by one or more processors to perform operations for communication by an access point (AP). The operations may configure the one or more processors to contend for a transmission opportunity (TXOP) to obtain access to a bonded channel comprising a primary channel in a first frequency band and one or more secondary channels, wherein at least one of the secondary channels is in a second frequency band. The operations may further configure the one or more processors to encode a null data packet (NDP) for concurrent transmission within the TXOP on the primary and secondary channels to enable separate sounding measurements on the primary and secondary channels. The operations may further configure the one or more processors to decode one or more beamforming feedback (BF) frames that include sounding measurements at a station (STA) for the primary and secondary channels based at least partly on training symbols included in the NDP. The operations may further configure the one or more processors to select, based at least partly on the sounding measurements, one or more modulation and coding schemes (MCSs) to be used for downlink communication with the STA on the primary and secondary channels.

In Example 17, the subject matter of Example 16, wherein the operations may further configure the one or more processors to encode an NDP announcement (NDPA) for concurrent transmission during the TXOP on the primary channel and on the secondary channel, wherein the NDPA includes information for the NDP transmission. The operations may further configure the one or more processors to encode, based on one or more data payloads, physical layer convergence procedure protocol data units (PPDUs) for synchronized transmission on the bonded channel during the TXOP. One of the PPDUs may be encoded for transmission on the primary channel in accordance with the MCS selected for the primary channel. For at least a particular secondary channel, one of the PPDUs may be encoded for transmission on the particular secondary channel in accordance with the MCS selected for the particular secondary channel.

In Example 18, a method of contention-based access to a bonded channel comprising a primary channel in a first frequency band and a secondary channel in a second frequency band may comprise selecting a random back-off count. The method may further comprise monitoring the primary channel during a first time period to determine whether the primary channel is idle. The method may further comprise monitoring the secondary channel during a second time period to determine whether the secondary channel is idle, wherein a starting time of the second time period is later than a starting time of the first time period. The method may further comprise determining whether to transmit on the bonded channel during an access period subsequent to the first and second time periods based on the monitoring of the primary and secondary channels, comprising: determining to transmit on the bonded channel during the access period when the primary channel is determined as idle for a duration of at least the back-off count plus an arbitrary inter-frame space number (AIFSN) and when the secondary channel is determined as idle for a duration of at least a short inter-frame space (SIFS); and otherwise determining to refrain from transmission on the bonded channel during the access period.

In Example 19, the subject matter of Example 18, wherein the method may further comprise, when it is determined to transmit on the bonded channel during the access period: encoding, based on a data payload, first and second physical layer convergence procedure protocol data units (PPDUs) for synchronized transmission on the bonded channel during the access period.

In Example 20, an apparatus of a station (STA) may comprise memory. The apparatus may further comprise processing circuitry. The processing circuitry may be configured to decode a null data packet (NDP) announcement (NDPA) received concurrently on a plurality of channels of a bonded channel. The NDPA may be received within a transmission opportunity (TXOP) obtained by an access point (AP), wherein the NDPA includes transmission information for an NDP. The processing circuitry may be further configured to determine sounding measurements for the channels of the plurality based on training symbols included in the NDP. The NDP may be received concurrently on the channels of the plurality within the TXOP. The processing circuitry may be further configured to encode, for transmission within the TXOP, one or more beamforming frames (BFs) that include the sounding measurements. The processing circuitry may be further configured to decode a data payload based on a plurality of physical layer convergence procedure protocol data units (PPDUs) received synchronously on the channels of the plurality within the TXOP. The plurality of channels may include a primary channel in a first frequency band and one or more secondary channels. At least one of the secondary channels is in a second frequency band.

In Example 21, the subject matter of Example 20, wherein the STA may be arranged to operate in accordance with a wireless local area network (WLAN) protocol.

In Example 22, the subject matter of one or any combination of Examples 20-21, wherein the processing circuitry may be further configured to decode a control frame or a management frame from the AP to establish an association between the STA and the AP for communication on the bonded channel. The establishment of the association may be restricted to the primary channel.

In Example 23, the subject matter of one or any combination of Examples 20-22, wherein the processing circuitry may be further configured to decode a frame that includes a capabilities element that indicates: one or more channels which the AP is configured to use as primary channels, or one or more channels which the AP is configured to use as secondary channels.

In Example 24, the subject matter of one or any combination of Examples 20-23, wherein at least one of the frequency bands may be a licensed frequency band and at least one of the frequency bands may be an unlicensed frequency band.

In Example 25, an apparatus may comprise means for contending for a transmission opportunity (TXOP) to obtain access to a bonded channel comprising a primary channel in a first frequency band and one or more secondary channels, wherein at least one of the secondary channels is in a second frequency band. The apparatus may further comprise means for encoding a null data packet (NDP) for concurrent transmission within the TXOP on the primary and secondary channels to enable separate sounding measurements on the primary and secondary channels. The apparatus may further comprise means for decoding one or more beamforming feedback (BF) frames that include sounding measurements at a station (STA) for the primary and secondary channels based at least partly on training symbols included in the NDP. The apparatus may further comprise means for selecting, based at least partly on the sounding measurements, one or more modulation and coding schemes (MCSs) to be used for downlink communication with the STA on the primary and secondary channels.

In Example 26, the subject matter of Example 25, wherein the apparatus may further comprise means for encoding an NDP announcement (NDPA) for concurrent transmission during the TXOP on the primary channel and on the secondary channel, wherein the NDPA includes information for the NDP transmission. The apparatus may further comprise means for encoding, based on one or more data payloads, physical layer convergence procedure protocol data units (PPDUs) for synchronized transmission on the bonded channel during the TXOP. One of the PPDUs may be encoded for transmission on the primary channel in accordance with the MCS selected for the primary channel. For at least a particular secondary channel, one of the PPDUs may be encoded for transmission on the particular secondary channel in accordance with the MCS selected for the particular secondary channel.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP), the apparatus comprising: memory; and processing circuitry, configured to:
contend for a transmission opportunity (TXOP) to obtain access to a bonded channel comprising a primary channel in a first frequency band and a secondary channel in a second frequency band;
encode a null data packet (NDP) announcement (NDPA) for concurrent transmission on the primary and secondary channels, wherein the NDPA includes NDP transmission information for the primary and secondary channels;
encode one or more NDPs that include training symbols, the NDPs for concurrent transmission on the primary and secondary channels to enable separate sounding measurements for the primary and secondary channels; and
decode one or more beamforming feedback (BF) frames that include the sounding measurements for the primary and secondary channels, the sounding measurements based on the training symbols of the NDPs.

2. The apparatus according to claim 1, the processing circuitry further configured to:
encode, for transmission, a frame that includes a capabilities element that indicates:
one or more channels which the AP is configured to use as primary channels, or
one or more channels which the AP is configured to use as secondary channels.

3. The apparatus according to claim 1, the processing circuitry further configured to:
select, based at least partly on the sounding measurements, a first modulation and coding scheme (MCS) for the primary channel and a second MCS for the secondary channel, the first and second MCSs for transmission of downlink multi-user multiple-input multiple-output (MU-MIMO) communications to a station (STA) within the TXOP.

4. The apparatus according to claim 3, the processing circuitry further configured to:
encode, based on a data payload, first and second physical layer convergence procedure protocol data units (PPDUs) for synchronized transmission on the bonded channel as part of the downlink MU-MIMO communications,
wherein the first PPDU is encoded based on the first MCS for transmission on the primary channel, and
wherein the second PPDU is encoded based on the second MCS for transmission on the secondary channel.

5. The apparatus according to claim 4, wherein the first and second PPDUs include physical layer (PHY) headers that indicate that the primary and secondary channels are used for the transmissions of the first and second PPDUs.

6. The apparatus according to claim 4, wherein:
the bonded channel is configurable to comprise one or more additional secondary channels in the first frequency band or second frequency band,
the processing circuitry is further configured to encode, based on the data payload, additional PPDUs for transmission in the additional secondary channels as part of the synchronized transmission on the bonded channel.

7. The apparatus according to claim 6, wherein:
the PPDUs include physical layer (PHY) headers that include control information related to the frequency bands of the primary channel and the secondary channels, and
the control information is repeated in the PHY headers of the PPDUs of the primary and secondary channels.

8. The apparatus according to claim 6, wherein:
the PPDUs include physical layer (PHY) headers that include control information related to the frequency bands of the primary channel and the secondary channels, and
the control information in the PHY header of the PPDU of a particular channel is dependent on the frequency band of the particular channel.

9. The apparatus according to claim 3, the processing circuitry further configured to select the first and second MCSs as a same MCS or as two different MCSs.

10. The apparatus according to claim 3, wherein:
the sounding measurements include a first signal quality measurement for the primary channel and a second signal quality measurement for the secondary channel, and
the processing circuitry is further configured to select the first and second MCSs from a candidate group of MCSs based at least partly on one or more predetermined thresholds.

11. The apparatus according to claim 1, wherein the AP is arranged to operate in accordance with a wireless local area network (WLAN) protocol.

12. The apparatus according to claim 11, the processing circuitry further configured to:
encode, for transmission, a control frame or a management frame to establish an association between the AP and a station (STA) for communication on the bonded channel,
wherein the establishment of the association is restricted to the primary channel.

13. The apparatus according to claim 1, wherein the first frequency band is a licensed frequency band and the second frequency band is an unlicensed frequency band.

14. The apparatus according to claim 1, wherein the processing circuitry includes a baseband processor to encode the NDPA, encode the NDP, and decode the one or more BF frames.

15. The apparatus according to claim 1, wherein the apparatus further includes a transceiver to transmit the NDPA, transmit the NDP and receive the one or more BF frames.

16. A non-transitory computer-readable storage medium that stores instructions for execution by one or more processors to perform operations for communication by an access point (AP), the operations to configure the one or more processors to:
contend for a transmission opportunity (TXOP) to obtain access to a bonded channel comprising a primary channel in a first frequency band and one or more secondary channels, wherein at least one of the secondary channels is in a second frequency band;
encode a null data packet (NDP) for concurrent transmission within the TXOP on the primary and secondary channels to enable separate sounding measurements on the primary and secondary channels;
decode one or more beamforming feedback (BF) frames that include sounding measurements at a station (STA) for the primary and secondary channels based at least partly on training symbols included in the NDP; and
select, based at least partly on the sounding measurements, one or more modulation and coding schemes (MCSs) to be used for downlink communication with the STA on the primary and secondary channels.

17. The non-transitory computer-readable storage medium according to claim 16, the operations to further configure the one or more processors to:
encode an NDP announcement (NDPA) for concurrent transmission during the TXOP on the primary channel and on the secondary channel, wherein the NDPA includes information for the NDP transmission; and
encode, based on one or more data payloads, physical layer convergence procedure protocol data units (PPDUs) for synchronized transmission on the bonded channel during the TXOP,
wherein one of the PPDUs is encoded for transmission on the primary channel in accordance with the MCS selected for the primary channel, and
wherein, for at least a particular secondary channel, one of the PPDUs is encoded for transmission on the particular secondary channel in accordance with the MCS selected for the particular secondary channel.

18. A method of contention-based access to a bonded channel comprising a primary channel in a first frequency band and a secondary channel in a second frequency band, the method comprising:
selecting a random back-off count;
monitoring the primary channel during a first time period to determine whether the primary channel is idle;
monitoring the secondary channel during a second time period to determine whether the secondary channel is idle, wherein a starting time of the second time period is later than a starting time of the first time period;
determining whether to transmit on the bonded channel during an access period subsequent to the first and second time periods based on the monitoring of the primary and secondary channels, comprising:
determining to transmit on the bonded channel during the access period when the primary channel is determined as idle for a duration of at least the back-off count plus an arbitrary inter-frame space number (AIFSN) and when the secondary channel is determined as idle for a duration of at least a short inter-frame space (SIFS); and
otherwise determining to refrain from transmission on the bonded channel during the access period.

19. The method according to claim 18, the method further comprising, when it is determined to transmit on the bonded channel during the access period:
encoding, based on a data payload, first and second physical layer convergence procedure protocol data units (PPDUs) for synchronized transmission on the bonded channel during the access period.

20. An apparatus of a station (STA), the apparatus comprising: memory; and processing circuitry, configured to:
decode a null data packet (NDP) announcement (NDPA) received concurrently on a plurality of channels of a bonded channel, the NDPA received within a transmission opportunity (TXOP) obtained by an access point (AP), wherein the NDPA includes transmission information for an NDP;
determine sounding measurements for the channels of the plurality based on training symbols included in the NDP, the NDP received concurrently on the channels of the plurality within the TXOP;
encode, for transmission within the TXOP, one or more beamforming frames (BFs) that include the sounding measurements; and
decode a data payload based on a plurality of physical layer convergence procedure protocol data units (PPDUs) received synchronously on the channels of the plurality within the TXOP,
wherein the plurality of channels includes a primary channel in a first frequency band and one or more secondary channels, wherein at least one of the secondary channels is in a second frequency band.

21. The apparatus according to claim 20, wherein the STA is arranged to operate in accordance with a wireless local area network (WLAN) protocol.

22. The apparatus according to claim 21, the processing circuitry further configured to:
decode a control frame or a management frame from the AP to establish an association between the STA and the AP for communication on the bonded channel,
wherein the establishment of the association is restricted to the primary channel.

23. The apparatus according to claim 21, the processing circuitry further configured to:
decode a frame that includes a capabilities element that indicates:
one or more channels which the AP is configured to use as primary channels, or
one or more channels which the AP is configured to use as secondary channels.

24. The apparatus according to claim 20, wherein at least one of the frequency bands is a licensed frequency band and at least one of the frequency bands is an unlicensed frequency band.
